(19) United States
(12) Patent Application Publication
(10) Pub. No.: US 2016/0316317 A1
(43) Pub. Date: Oct. 27, 2016

(54) SYSTEM AND METHOD FOR UTILIZING INFORMATION FROM AN RFID TAG ASSOCIATED WITH AN ARTICLE

(71) Applicant: Erika Mayiras, North Olmsted, OH (US)

(72) Inventor: Erika Mayiras, North Olmsted, OH (US)

(21) Appl. No.: 15/140,433

(22) Filed: Apr. 27, 2016

Related U.S. Application Data
(60) Provisional application No. 62/153,156, filed on Apr. 27, 2015.

(51) Int. Cl. H04W 4/00; H04W 12/10; G06F 17/30; H04W 12/08; H04W 52/28; G06Q 10/00; H04W 4/02; H04W 12/06

(52) U.S. Cl. CPC H04W 4/008; H04W 4/025; H04W 12/10; H04W 12/06; H04W 12/08; H04W 52/28; G06Q 10/20; G06F 17/30477

(57) ABSTRACT

A method and system is disclosed for using RFID tags associated with articles of commerce with standard mobile wireless devices and application software used as readers for identifying and tracking articles before and after the sale of the article. Information is used to enhance product marketing by manufacturers and resellers, to identify and authenticate desirable articles and provide information on cost and where the article can be purchased by the general public, to care for the article and log its usage over time, and to track the location of the article over time. Operation may also occur via automated software control, using available mobile wireless devices as a free or very low cost ad hoc wireless network.

### RELATED APPLICATION

This application claims priority to U.S. Provisional Patent Application Serial No. 62/163,156, titled “System and Method for Utilizing Information From an RFID Tag Associated with an Article,” which was filed on Apr. 27, 2015, which is expressly incorporated by reference herein in its entirety.

### FIELD OF INVENTION

The present disclosure generally relates to the use of RFID, wireless, and database technology in cooperation with articles of commerce. More specifically, the present disclosure relates to use of RFID tags associated with articles of commerce, handheld communication devices located in the vicinity of the article of commerce, and remote databases to gather and utilize information relevant to the article of commerce.

### BACKGROUND

Radio Frequency Identification (RFID) technology is a relatively well-developed field. RFID technology can be applied to automated identification, tracking, and authentication of articles of commerce in a logistical chain from manufacturer to retailer. Such identification of articles can improve upon expensive error-prone human methods for tracking of articles and replace such human methods with lower cost and more accurate automated tracking and database updating methods. RFID technology provides a higher degree of automation than bar code reading, for example, which inherently involves human action.

RFID technology typically utilizes an RFID tag attached to or associated with an article and an RFID reader that can interrogate RFID tags and retrieve information stored on the RFID tag. RFID technology uses several types of RFID tags and techniques. For example, RFID tags and readers can utilize both Low Frequency (“LF,” generally below 150 kHz) or High Frequency (“HF,” generally at 13.56 MHz as governed by international regulatory agreement). Information can be transferred through induction (i.e., magnetic field based information transfer) with LF and HF passive RFID tags. A passive tag is one without an onboard battery or other power supply. Passive tags generally really on the interrogation signal for energy through which to reflect or otherwise create a signal that responds to the interrogation signal. Systems based on passive tags typically have relatively short transmission ranges of about one centimeter to about ten centimeters. However, techniques that use higher power interrogations and larger coil antennas can expand the range of passive RFID tags to about one meter.

Passive Ultra-High Frequency (“UHF”) systems, most commonly in the frequency range of 850 to 950 MHz, use true radio propagation (electric and magnetic field propagation) and can generally achieve ranges of about one to ten meters. Active RFID tags with internal batteries to power the RFID tag's transmitter, generally operating in specially allocated bands or in the Industrial, Scientific, and Medical (ISM) bands near 900 MHz and 2.4 GHz. Such arrangements of active RFID tags can generally achieve ranges of tens to hundreds of meters. Active RFID tags typically cost more than passive or battery-less systems. Due to their higher cost, active RFID systems are generally used only to track higher value and more critical goods, such as pallets and shipping containers containing numerous articles and military supplies.

The present disclosure uses RFID tags and systems, such as those described herein, for novel methods, apparatus and systems for utilizing information from such RFID tags associated with an article of commerce. Information from RFID tags associated with an article of commerce can be used for marketing, advertising, authentication, tracking, and other such activities.

### BRIEF DESCRIPTION OF THE DRAWINGS

In the accompanying drawings, structures are illustrated that, together with the detailed description provided below, describe example embodiments of the disclosed systems, methods, and apparatus. Where appropriate, like elements are identified with the same or similar reference numerals. Elements shown as a single component can be replaced with multiple components. Elements shown as multiple components can be replaced with a single component. The drawings may not be to scale. The proportion of certain elements may be exaggerated for the purpose of illustration.

FIG. 1 schematically illustrates an exemplary system using an RFID tag associated with an article of commerce, a handheld device, and a remote server.

FIG. 2 depicts a flowchart of an exemplary method of using the system of FIG. 1.

FIG. 3 schematically illustrates a system for securing information stored on an RFID tag.

FIG. 4 depicts a flowchart of an exemplary method of using the system of FIG. 3.

FIG. 5 schematically illustrates an exemplary system for facilitating determination of the location of an article.

FIG. 6 schematically illustrates an exemplary system for facilitating an ad hoc wireless network for use with RFID tags.

### SUMMARY

A method and system is disclosed for using RFID tags associated with articles of commerce with standard mobile wireless devices and application software used as readers for identifying and tracking articles before and after the sale of the article. Information is used to enhance product marketing by manufacturers and resellers, to identify and authenticate desirable articles and provide information on cost and where the article can be purchased by the general public, to care for the article and log its usage over time, and to track the location of the article over time. Operation may also occur via automated software control, using available mobile wireless devices as a free or very low cost ad hoc wireless network.

One embodiment disclosed herein includes a method of authenticating the validity of a manufactured item or procuring further information about the item. The method includes a step of associating embedded electronics containing a wireless transmitter with the item for transmitting identifying information of the item comprising a class identity for the item. The method further includes the step of a wireless receiver receiving said identifying information, where the receiver is embedded as a standard feature in a handheld wireless device. The handheld wireless device has a capability to query a remote database to retrieve information on how such item or similar item may be purchased and under what terms.

Another embodiment disclosed herein includes the method of gathering information regarding an item in order to predict the remaining lifetime of the item and improve manufacturing processes and design of the item. The method includes the step of associating embedded electronics containing a wireless transmitter with the item for transmitting information regarding the item. The information includes temperature awareness to detect and log when the item is exposed to extreme temperatures or used in conditions detrimental to appearance or service life of the item.

Another embodiment disclosed herein is a system for improving the security of an owner or carrier of tagged property. The system includes a wireless device for reading data from a tag associated with the property. The data includes at least one of the identity of the property, the identity of the user of the property, location of the property, and time. A radio link can be used to send data to a server maintaining a database of such data. Optionally, the system can include a timer that limits access to data based on the preference of the owner of the property.

Another embodiment disclosed herein is a method for authenticating the validity of a manufactured item or providing real time marketing information back to the manufacturer or reseller of the item. The method includes embedding a wireless transmitter into the item that transmits identifying information on a periodic basis, The information includes a class identity for the item. The method further includes providing a wireless receiver to receive said identifying information. The wireless receiver can be embedded in a common handheld wireless device. The handheld wireless device has a capability to wirelessly report the identifying information combined with at least one of date and location to a server. The server can be made accessible to the manufacturer or reseller of the item. The method can optionally further include providing real time information to owner of the item, potential user of the item, manufacture of the item, or law enforcement authorities.

Another embodiment disclosed herein is a method of providing user control over a tag embedded in a manufactured item following its initial sale. The method includes embedding the tag into the item and providing with the tag a wireless transmitter to transmit identifying information. Such information including a class identity for the item. The method further includes providing a wireless receiver to receive the identifying information. The receiver can be embedded as a standard feature in a handheld wireless device. The handheld wireless device includes the capability to be location aware. The method further includes providing the user of the item the ability to adjust the operation of the tag. The method can optionally include the requirement that the user enter a password to adjust operation of the tag. Such adjustments to operation can include disabling transmissions, altering the time of transmissions, or reducing the power of the transmission as a function of the location of the tag.

### DETAILED DESCRIPTION

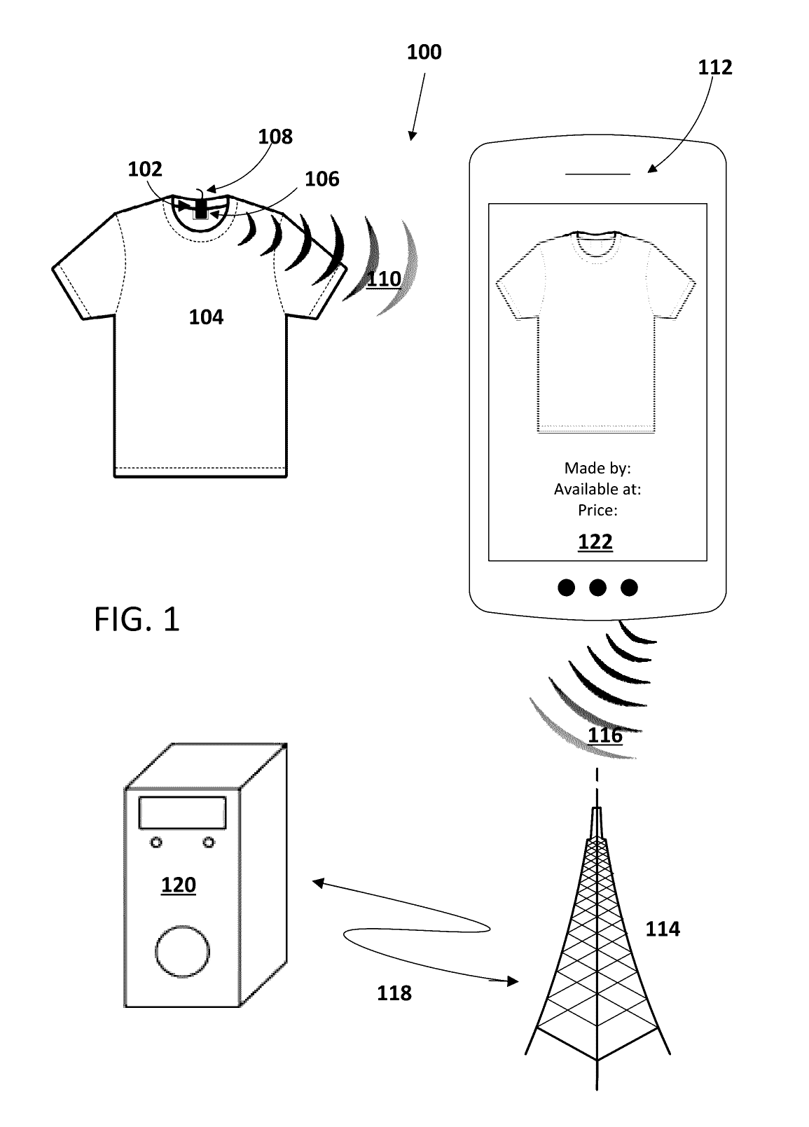

The apparatus, systems, arrangements, and methods disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of apparatus, arrangements, and methods for facilitating the use of information from an RFID tag associated with an article of commerce are hereinafter disclosed and described in detail with reference made to FIGS. 1-6.

The systems, apparatus, and methods disclosed herein provide for convenient, unobtrusive, secure, user-controllable identification, authentication, information retrieval, and tracking of location of an article of commerce. In one example, such systems, apparatus, and methods can be used in a retail store environment prior to a consumer purchasing the article. In another example, such systems, apparatus, and methods can be used outside the retail store environment once the consumer has purchased the article. Convenient use of the system, apparatus, and methods can be facilitated by the use of relatively long range active RFID tags attached to or otherwise associated with the article of commerce. Such relatively long range active RFID tags provide for interrogating the RFID tag to retrieve information about the article without the need to closely approach the article.

The systems, apparatus, and methods can use standard consumer mobile wireless devices such as smart phones, wireless tablets, smart watches, and the like. Modern mobile wireless devices typically include a primary universal coverage wireless link such as cellular with internet access and a secondary shorter range radio links such as Bluetooth and Wi-Fi, which can access and interrogate RFID tags. Such secondary shorter range radio links typically operate in the range of up to about 100 meters. Modern mobile wireless devices can also be arranged to determine the location of the devices using embedded Global Positioning System (GPS) capability that is typically built into the mobile device. The systems, apparatus, and methods can determine the location of an article equipped with an RFID tag by utilizing a wireless device as an RFID reader when the device is within the range of the secondary radio link. The RFID tag can be detected and interrogated by a mobile device, and the mobile device can determine the relative location of the RFID tag, and thus the relative location of the article, by evaluating the signal strength sensed from the RFID tag. The mobile device can then further determine the location of the article of the using the mobile device's GPS capability and the sensed signal strength from the RFID tag. It will be appreciated by one of ordinary skill in the art that the location of the mobile device can be attributed the article of commerce. However, it will also be appreciated that the location of the article in commerce can also be determined to be within a calculated radius of the mobile device.

As will be described herein, an article with an associated RFID tag can serve as an effective advertising platform regardless of the location of the article. For example, a consumer that is interested in purchasing the article or learning more about the article can use a mobile device to detect and retrieve information from the RFID tag associated with the article. The retrieved information can provide details regarding the article, including where such an article can be purchased, specifications for the article, and so on. Such information can be received by the consumer's mobile device retrieving a unique identifier for the article from the RFID tag and using that unique identifier to wirelessly downloading information about the article from a manufacturer, distributers, resellers, and/or retailers remote database.

When mobile devices are present in sufficient density in an area of operation, which is commonly the case in urban areas or retail locations, and if the mobile devices are equipped with appropriate software or applications, such mobile devices may provide an automated ad hoc free or nearly free network of mini-base-stations. Such a network of mini-base-stations can, under certain conditions, automate the processes of retrieving information from RFID tags and provide identification and location information for the articles associated with the RFID tags. Ad hoc network reliability can be improved with usage of interspersed fixed wireless devices as longer range mini-base-stations.

Additional utility can be provided to the user of disclosed systems, apparatus, and methods by utilizing the RFID tag as a temperature sensor that can detect, for example, when and for how long an article of clothing is worn, and what temperatures the article has been exposed to when cleaned, which together can provide a log of article usage and an estimation of remaining lifespan of the article. The lifespan of the article can be reported back to manufacturers of the article to inform improvements to the article's design and manufacturing processes. Manufacturers, distributors, resellers, and retailers may also enhance the marketing of an article by considering reliable reports of where and when the article is being used. Such reports can rely on location information generated by mobile wireless devices with embedded GPS capability. Location information can also be generated by a mobile wireless device with cellular or Wi-Fi capabilities. Additional marketing utility can derive from disclosed systems and apparatus providing automated connections to social networking platforms to facilitate the exchange of information. Similarly, marketing utility can be derived from automated connections to interactive gaming and contesting.

Owners of an article can enhance the security of the information stored on an RFID tag associated with the article by restricting transmissions of information from the RFID tag, by allowing access to the information to only authorized wireless mobile devices, and by encryption of the information, which can be decrypted only by authorized users. Additional security for owners of an article is enhanced by creating a log that documents who or what wireless device has read information from the RFID tag and when and where the information was read.

FIG. 1 illustrates an exemplary system 100 for use with methods, systems, and apparatus disclosed herein. The system 100 can include an RFID tag 102 embedded or otherwise attached to or associated with an article 104. The RFID tag 102 can include a body 106 and an antenna 108. The article 104 can be any type of article, including a consumer product or any other article of commerce. As illustrated in FIG. 1, the article 104 can be an article of apparel such as a shirt. In one embodiment, the RFID tag 102 can be an active RFID tag that is secured to the article 104. In one example, the RFID tag 102 can be secured to a label sown into a seam along the neck of the shirt 104. In another example, the RFID tag 102 can be secured to the shirt 104 by being woven into the fabric of the shirt 104. The antenna 108 can be constructed of a conductive, flexible thread woven into the shirt 104. The body 106 and antenna 108 of the RFID tag 102 can be arranged so that when the shirt 104 is worn, the RFID tag 102 generally flexes and contorts to maintain its integrity as it accommodates the movement of the shirt 104.

The RFID tag 102 can be arranged to send and/or receive signals 110 that can be encoded with information. The RFID tag 102 can communicate via a number of communication protocols. In one embodiment, the RFID tag 102 can include a radio transceiver (not shown) arranged to communicate via a radio link. Such a radio link can be of the type that is typically used to communicate with standard consumer wireless devices such as smart phones and tablets. One example of such a radio link is governed by the IEEE 802.11 and similar standards, commonly known as wireless local area network or Wi-Fi. Another example of such a radio link is governed by the IEEE 802.15.1 standard, commonly known as Bluetooth. Such radio links can provide for communications ranging between several meter to well over a 100 meters.

In one example, the RFID tag 102 can be arranged to operate on a relatively low power demand. For such low power RFID tags 102, the radio transceiver can operated on a Bluetooth standard, such as Bluetooth Low Energy (Bluetooth LE). In such an embodiment, a relatively small battery such as a lithium coin cell can power the RFID tag 102 to facilitate communications across an acceptable range. For example, the RFID tag 102 can be arranged to communicate reliably over a range of tens of meters and to communicate intermittently over a range of 100 meters or more.

As noted above, the RFID tag 102 can be arranged to send and/or receive signals 110 encoded with information. The RFID tag 102 can transmit information to and receive information from a variety of electronic devices. For example, as illustrated in FIG. 1, the RFID tag 102 can transmit information to and receive information from a handheld device 112 such as a smart phone, tablet, smart watch or other consumer mobile wireless device. The information exchanged between the RFID tag 102 and the handheld device 112 can include information about the article 104, information about similar articles, information about the user of the article 104, information about the user of the handheld device 112, or any other such category of information.

The handheld device 112 can further communicate with base-stations 114 to relay information received from the RFID tag 102 and to request additional information about the article 104 associated with the RFID tag 102. Examples of such base-stations 114 are cellular towers (as illustrated in FIG. 1) or local wireless network device such as a modem or router (i.e., a Wi-Fi device). The handheld device 112 can communicate with such base-stations 114 by sending signals 116 over any wireless network such as for example cellular signals or Wi-Fi signals (which can facilitate both communications between RFID tags 102 and handheld devices 112 and communications between handheld devices 112 and base-stations 114). As will be understood, the handheld device 112 can effectively serve as a “mini-base-station” to facilitate communications between the RFID tag 102 and a base-station 114 such as a cellular tower. In such an arrangement, the signal 116 between the handheld device 112 and the base-station 114 can be referred to as a “backhaul” link.

The base-station 114, whether a cellular tower or a Wi-Fi device, can in turn have various “backhaul” options 118 for communicating with a server 120. Such communications can include information about the article 104. It will be understood that such article information can be stored in databases or other such data structures on the server 120. Such backhaul options 118 include several types of communication links in series, at least one of which can be internet-based to communicate with servers 120 that have internet access. Once communications reach the server 120, the server 120 can return information about the article 104 to the base-station 114. In one example, the information can be returned to the base-station 114 at least partially using the internet.

The base-station 114 can subsequently relay information from the server 120 to the handheld device 112. The handheld device 112 can include an application 122 residing on the handheld device 112 such as a downloadable mobile software application. Such an application 122 can be arranged to display information received from the server 120 that is pertinent to the user of the handheld device 112. For example, the information can include details about the article 104 such as manufacturer of article, name of article, price of the article, retail outlets and websites where article can be purchased, and so on. The user of wireless device 112 via the application 122 can direct additional inquiries to the database located on the server 120 to retrieve additional pertinent information to be displayed via the application 122.

Additionally, the exchange of information between the RFID tag 102 and the server 120 via the handheld device 112 and base-station 114 can provide information to a manufacturer, distributor, reseller, and/or retailer of the article 104. The manufacturer, distributor, reseller, and/or retailer can participate in a service that utilizes the RFID tag 102 to provide information and data regarding the article 104 to such interested parties. Such information and data can be organized in a report and include information such as purchase locations and options.

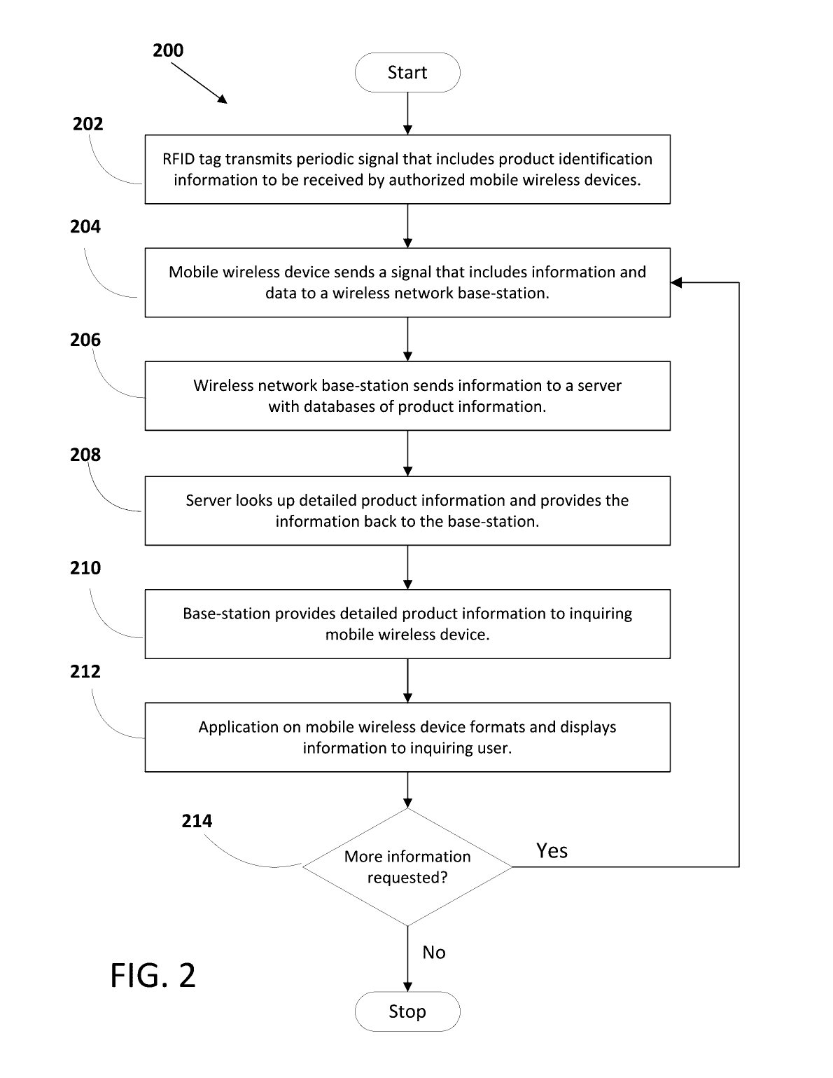

FIG. 2 is a flowchart depicting an exemplary method 200 for using the system 100 illustrated in FIG. 1. The RFID tag 102 can be arranged to periodically send a signal 110 that includes information about the article 104. The signal 110 is typically intended to be received by handheld devices 112 that are in the vicinity of the article 104 and are authorized to receive such signals 110 and information. The exemplary method 200 begins with step 202, where the RFID tag 102 periodically sends or transmits a signal that include information identifying the article 104. In one example, the information identifying the article can include a Universal Product Code (“UPC”). A UPC code, which is also used with barcode technology, is a code that typically includes twelve alpha-numeric characters. In another example, the article information can be an Electronic Product Code (EPC), which typically includes 32 to 256 bits of information.

As the signal 110 is periodically sent, the signal 110 can be received by an authorized handheld device 112, and the handheld device 112 can ascertain the information and data included in the signal 110. Once the signal 110 is received by the handheld device 112, the method continues with step 204, where the handheld device 112 sends a signal 116 that includes information and data to a base-station 114. As described herein, the handheld device 112 can send signals 116 and transfer information over a wireless network, such as cellular and Wi-Fi networks, to a base-station 114 such as a cellular tower or a Wi-Fi device. The handheld device 112 can enhance the information and data by including information such as time the signal 116 is sent and location of the handheld device 112 at the time the signal 116 is sent.

Once the information is received by the base-station 114, the method continues with step 206, where the base-station 114 passes this information on to a server 120. As described herein, the information can be transmitted from the base-station 114 to the server 120 at least partially via an internet based operation. The server 120 can include databases and other data structures the organize information and data about products and other articles of commerce, including information and data about the article 104 that is subject to the method 200.

Once the information has been received by the server 120, the method continues with step 208, where the server 120 retrieves detailed information regarding the article 104, and transmits the retrieved information back to the base-station 114. It will be understood that the server 120 can use a number of techniques to retrieve detailed information regarding the article 104 such as performing database searches and look-ups.

Once the base-station 114 receives the retrieved information, the method continues with step 210, where the base-station 114 transmits the information to the authorized handheld device 112. When the handheld device 112 receives the information, the method continues with step 212, where the application 122 displays the information on the handheld device 112 for the user of the handheld device 112 to view and evaluate. Once the user views and evaluates the information, the method can end, or the method can continue with step 214, with the user requesting more information.

It will be understood that such a request by the user for more information can be transmitted by the handheld device 112 to the base-station 114, which in turn can transmit the request to the server 120. Once received by the server 120, the server 120 can retrieve the requested information if available, transmit the information to the base-station 114, which in turn can transmit the information to the handheld device 112 for display by the application 122 and viewing by the user. The user can continue to request additional information in this manner until the user no longer desires additional information or the user has received all available information.

The systems, apparatus, and methods described herein can include security measures to protect the information transmitted by the systems, apparatus, and methods. Security of information embedded in RFID tags attached to articles can be of importance to owners of the articles, whether a retailer displaying the article for sale or a purchaser and owner of the article. Such owners may desire that only authorized handheld devices access the information on an RFID tag attached to an article. Unauthorized access to information stored on an RFID tag can lead to theft and other such problems. One method of securing information stored on an RFID tag is to disable the RFID tag's ability to transmit information. Another method of securing information stored on an RFID tag is to alter transmissions originating from RFID tags.

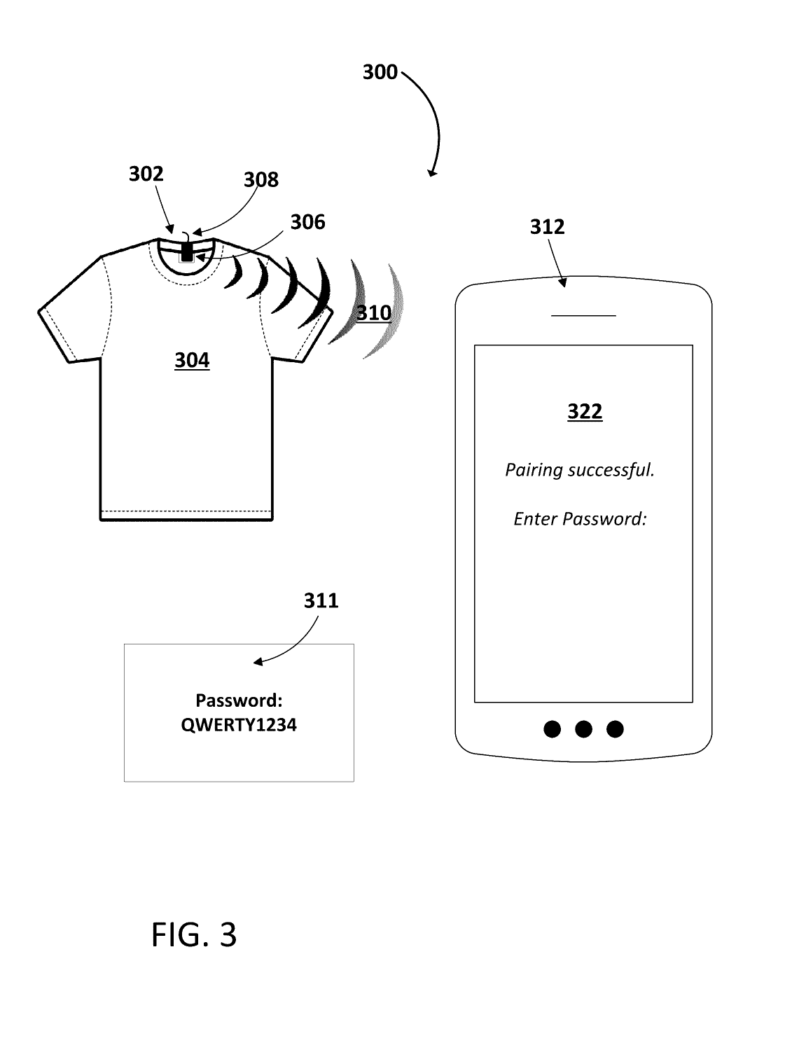

FIG. 3 illustrates a system for securing information stored on an RFID tag. The system 300 of FIG. 3 includes an RFID tag 302 attached to an article 304 such as a shirt. The RFID tag 302 includes a body 306 and an antenna 308. When the article 304 is sold, the owner of the article 304 is separately provided with a security code 311 such as a password. As illustrated in in FIG. 3, the security code 311 can be a combination of alpha-numeric characters that would be difficult to determine without access to the security code 311.

Once in possession of the article 304 and security code 311, the owner can perform an operation, or allow others to perform an operation, that authorizes certain handheld devices 312 to access the information on the RFID tag 302. One example of such an operation is a pairing operation. An application 322 on a handheld device 312 can detect the RFID tag 302 attached to the article 304, but cannot access the information on the RFID tag 302. To allow the application 322, and thus the handheld device 312, to access information on the RFID tag 302, the application 322 can be arranged to prompt the user for the security code 311. Once the article owner or a person authorized by the article owner enters the security code 311 into the application 322, the application 322 is authorized to access information on the RFID tag 302.

In one embodiment, once the application 322 is authorized to access information on the RFID tag 302, the article owner or other authorized person can use the application 322 to optionally apply security settings, procedures, and/or operational limits to the RFID tag 302. Examples of such security settings, procedures, and/or operational limits include: (i) permanently or temporarily disabling the RFID tag 302 such that the RFID tag 302 will no longer transmit any information or respond to any command; (ii) arranging the RFID tag 302 to only respond to commands from applications 322 and handheld devices 312 that can also provide the correct security code 311; (iii) selecting the rate or schedule of periodic transmissions of information from the RFID tag 302; (iv) selecting the power output of periodic transmissions from the RFID tag 302 to control the range of such transmissions (in one example, the power can be lowered to limit range for security purposes, in another example, the power can be increased to facilitate tracking and locating operations that may be desirable for pet owners to locate a pet or a parent to locate a child); (v) encrypting transmissions from the RFID tag 302 so that only handheld devices 312 with the proper decryption key can receive and read information from the RFID tag 302 (in one example, access to information on an RFID tag 302 can be limited to the owner's family members and other directly authorized by the owner); and (vi) restriction access to information on the RFID tag 302 to handheld device owners that have registered the device 312 as a user of the system. As will be understood, such security settings, procedures, and/or operational limits can prevent unauthorized access or an anonymous reading of information stored on the RFID tag 302.

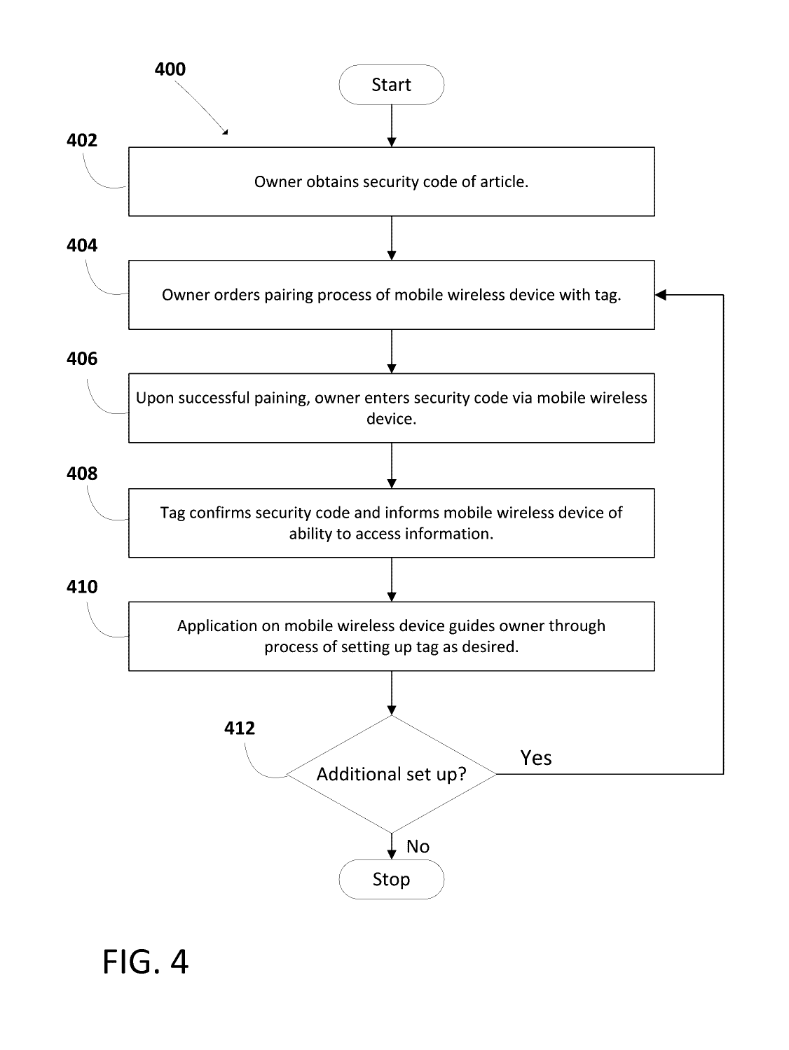

FIG. 4 is a flowchart depicting an exemplary method 400 for using the system 300 illustrated in FIG. 3. The exemplary method begins with the step 402 of the owner of an article 304 with an associated RFID tag 302 obtaining a security code 311 that is unique to the article 304. The owner can obtain the security code 311 either directly or indirectly. For example, the security code 311 can be included with the article 304 upon purchase such as in the packaging of the article 304. In another example, the security code 311 can be downloaded from a website or other remote location using a serial number or password associated with the article 304. Such download methods can be convenient for downloading the application 322 and other associated software for controlling access to the RFID tag 302.

Once the owner of the article 304 obtains the security code 311, the method continues with step 404, where the owner pairs the handheld device 312 with the RFID tag 302. As discussed herein, the handheld device 312 can be a smart phone or tablet capable of communicating via the Bluetooth protocol. Such handheld devices 312 are commonly used to pair with other devices to transmit and receive information. As will be understood, such pairing allows for unique communications between the RFID tag 302 and the handheld device 312.

Once the RFID tag 302 and the handheld device 312 are paired, the method continues with step 406, where the user of the device enters the unique security code 311 via the application 322. In step 408, the RFID tag 302 recognized the security code 311, and thus, recognizes the user as an authorized user that can access information on the RFID tag 302 and/or set security settings, procedures, and/or operational limit for the RFID tag 300. Once the RFID tag 302 recognizes the user is authorized, the method continues with step 410, where the application 322 on the authorized user's handheld device 312 guides the authorized user through setting a desired security setting, procedure, or operational limit for the RFID tag 302. The method continues to step 412, where the authorized user can stop the method or continue to set desired security settings, procedures, and/or operational limits for the RFID tag 302.

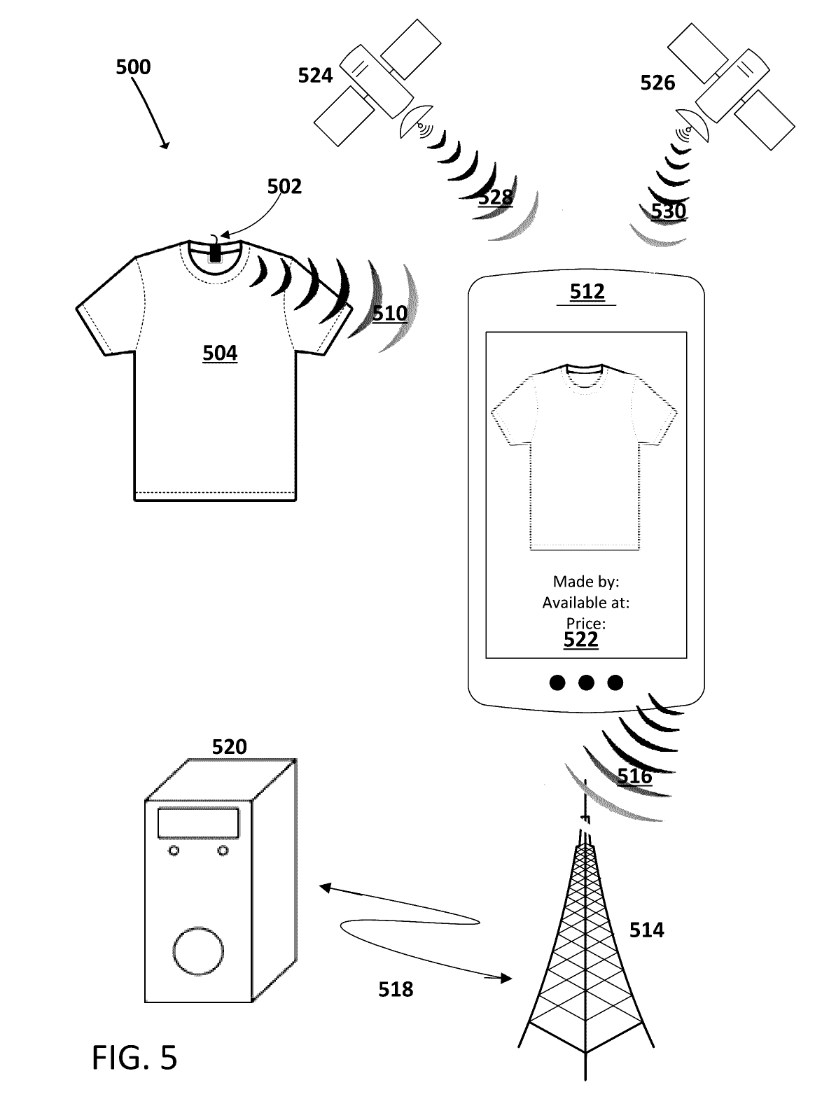

As discussed herein, systems, apparatus, and methods can be arranged to identify or track the location of an article. FIG. 5 illustrates an exemplary system 500 for facilitating determination of the location of an article 504. In one embodiment, location of an article 504 is facilitated by the global positioning system chip or device embedded in a handheld device 512 that communicates with an RFID tag 502 attached to the article 504. Global positioning system (GPS) satellites 524 and 526 send signals 528 and 530 that are received and interpreted by the GPS chip in the handheld device 512 to determine the location of the handheld device 512. Although only two GPS satellites are shown, it will be understood that location accuracy can be increased by additional GPS satellites. The location information determined by the handheld device 512 can be useful in a variety of ways. The location information can be used by manufacturers, distributors, resellers, and retailers to better understand the manner in which the article 504 is used. By having access to such location information as a function of time, such interested parties can enhance their marketing methods and operations. With regard to security, the location information can populate a database of a particular article's 504 location as a function of time. Such information could be useful by law enforcement in the event the article 504 was stolen or misplaced.

An application 522 downloaded onto the handheld device 512 can be arranged to automatically upload location and time information whenever the handheld device 512 detects the presence of the article 504. Furthermore, such location and time information can be associated with a specific handheld device 512 and/or user of the handheld device 512. Such methods for determining and tracking location (i.e., location awareness or position aware operations) can also allow deliberate tracking of RFID tags 502 that are of particular importance, such as RFID tags 502 that are associated with children or pets. It will be appreciated that such location awareness operations can be useful in locating lost children or pets. If a significant number of handheld devices 512 in circulation are equipped with applications 522 that can detect the presence of an RFID tag 502, then the location of the RFID tag 502 can be regularly reported, which can allow for reliability of location awareness operations to accurately determine the location of the RFID tag 502 and those articles 504 associated with the RFID tag 502.

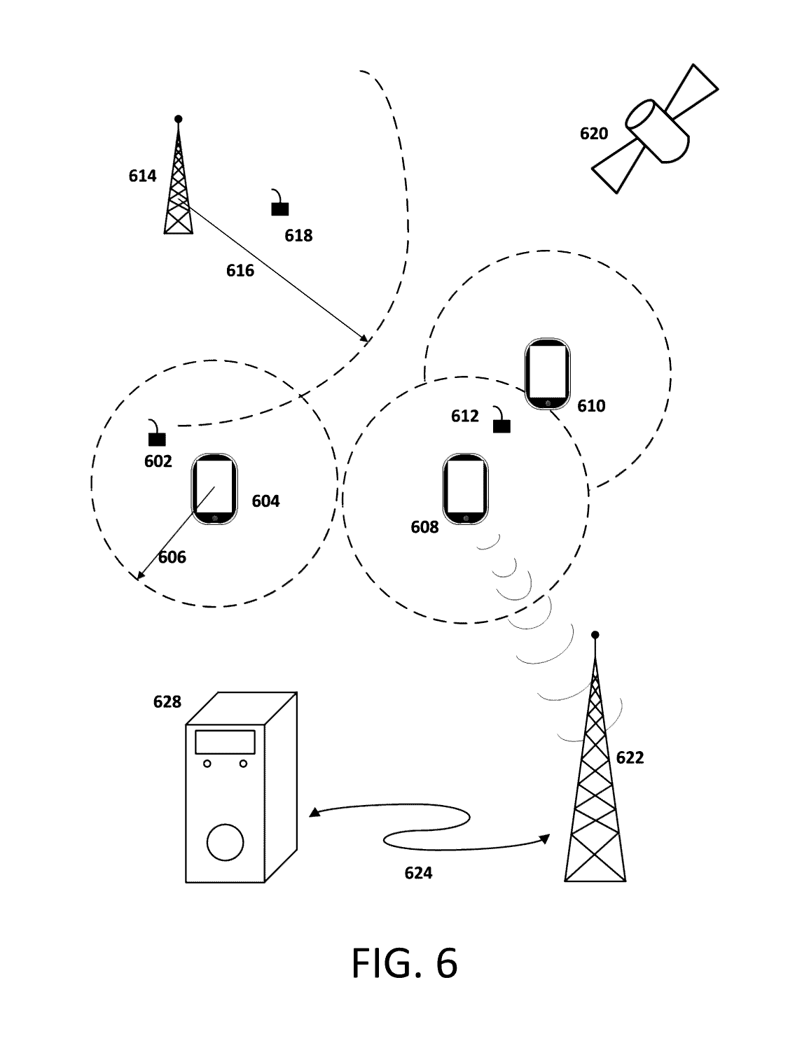

FIG. 6 illustrates an exemplary system for facilitating an ad hoc wireless network for use with RFID tags. The system includes a plurality of handheld devices 604, 608 and 610 that can function as a system of mini-base-stations to create an effective ad hoc wireless network. The use of privately owned handheld devices to create an ad hoc wireless network can be facilitated by the authorization of the owners of the handheld devices. Such authorization can be gained in a variety of ways.

In one example, a first handheld device 604 has a given effective range 606 of approximately 100 meters such that it can detect and access information stored on RFID tag 602. Whereas RFID tag 612 can be detected and accessed by both a second handheld device 608 and a third handheld device 610. However, RFID tag 618 is out of range of all three of handheld devices 604, 608, and 610. In such an example, a fixed wireless device 614, with a relatively large range 616 that is substantially larger than range 606, is able to access RFID tag 618. This relatively large range 616 can be the result of the advantageous mounting of fixed wireless device 614, and its use of a superior gain antenna.

RFID tags as described herein can be arranged so as to be attached to articles of clothing or other appeal without being intrusive or cumbersome. For example, the antenna of the RFID tag can be made to be unobtrusive by arranging the antenna as a thin flexible wire woven into the fabric of the clothing. Battery size can be minimized while maintaining battery life by implementing energy harvesting mechanisms, methods, and techniques that allowing for use of a smaller battery with an indefinite battery life. Some examples of such techniques and methods include use of both natural and artificial light, use of vibration including sound waves, use of general movement of the article, and use of heat, which can be generated by the environment surrounding the article or by a wearer of an article of clothing. Examples of thermoelectric apparatuses and techniques (i.e., generating electricity through heat energy) are described in U.S. Patent Publication No. US2013/0312806, titled Thermoelectric Apparatus and Applications Thereof, published on Nov. 28, 2013, which is expressly incorporated by reference herein in its entirety.

As will be understood by those of skill in the art, the systems, apparatus, and methods described herein can achieve certain advantages for users of the systems, apparatus, and methods. In one example, an article sold with an attached RFID tag can function as a highly accessible moving advertisement for additional sales of the article. Potential consumers interested in the article can efficiently determine the identity of the article and where the article may be purchased by using a smart phone or similar mobile wireless device that is already in the possession of the potential consumer. In another example, a manufacturer, distributor, reseller, or retailer can be provided with valuable information regarding the article such as where and when the article is used, how many times the article has been used in the past, and how the article withstands wear and tear. Such information can influence manufacturers to include RFID tags in articles and encourage downstream partners to accept any additional costs of including RFID tags in articles of commerce.

In another example, the RFID tag can be used to authenticate articles and protect against counterfeiting of the article. In one example, a potential buyer of an article can use an application on the user's handheld device to inspect the information on the RFID tag associated with the article. The application or the user can evaluate the information retrieved from the RFID tag do determine if the article is a genuine article. This is to say that the article is manufactured by company displayed on labels and packaging for the article. Such an application can be used by the buyer to avoid buying “knocked-off” products.

In another example, the systems, apparatus and methods provide benefits by providing article location awareness. Such benefits include tracking of stolen articles by determining the location of the article. Such benefits can be enhanced by the use of a plurality of authorized mobile devices in the vicinity of the article. In addition, access to information on the RFID tag can be blocked for criminals and other unauthorized persons. Another benefit is enhancing the personal security of the owner or wearer of an article of clothing with an attached RFID tag. For example, providing information on location of a child to a parent privately and securely over time.

Further the systems, apparatus, and methods can provide for the “Internet of Things” from the product owner and general public point of view, such as for item connection to social networking platforms, logging of usage over product lifetime and estimate of remaining service life, advising on care of the product, and downloading new product data to the tag over the product lifetime. It enhances the relationship between the owner of a tagged item and the item, which enhances the desirability and marketability of the item. The intelligence, wireless internet connectivity, user control of the RFID tag, and GPS position awareness of the RFID tag support interactive gaming and contesting that are useful in product marketing. Temperature monitoring of the item over its lifetime allows for detecting when an item of clothing is worn, for how long, advising of too high a temperature being used during drying, and for optionally reducing transmissions when not in use in order to maximize tag battery life.

The mobile devise application that facilitates the systems, apparatus and methods disclosed herein can include a number of functionalities. In one example, the application supports the creation of a “wish list.” The user or owner of the mobile device can place desired items on such a wish list. As the user of the mobile device shops, the mobile device can inspect RFID tags attached to articles of commerce and provide any gathered information to the application. When the application detects the presence of one of the items on the wish list, the application can alert the user of the mobile device of the presence of a desired item and the user of the mobile device can act on such an alert by viewing and/or buying the desired item. The application can further include functionality for using identifying information about the article retrieved from the RFID tag associated with the article to request and download instructional information from a remote server. Such instructional information can include how-to videos, assembly instructions, owners and users manuals, and the like.

The application downloaded to the mobile device can provide additional services to the mobile device user in organizing articles owned by the mobile device user. For example, the application can include a database of clothing items owned by the mobile device user, i.e., the user's “closet.” The application can use such a database to assist the user in selecting an outfit to wear. The application can synch with other applications or gather information such as the user's calendar events and type of activities listed on the calendar, the general weather and ambient temperature at the location of a specific event. The application can use such information to recommend an outfit for the user that suits the activity and expected weather. The application can also keep track of the articles of clothing worn by the user in the past. The application can then recommend outfits to avoid the user wearing the same outfit among a given group of people. For example, if the user attends a weekly meeting for an organization, the application can track the outfits worn to the weekly meeting and suggest outfits for the user that have not been recently worn to the weekly meeting.

The application can facilitate interaction with social media. The user can use the application to “set trends” and “follow trends.” The user can scan a combination of clothing articles to create a “daily style” that can be posted to social media to set trends and gain follows on the social media platform. Prizes such as discounts or free merchandise from clothing brands and be awarded to those with the most followers.

The application can also be arranged to find misplaced items. For example, if a shirt with an RFID tag is misplaced in the owner's home, the owner can use a mobile device and the installed application to search for the shirt in the house. The application can provide feedback of whether the user is “hot” (i.e., close to the item) or “cold” (i.e., far away from the item) based on the signal strength of the RFID tag associated with the shirt. The user can hone in on the item by evaluating such “hot” and “cold” feedback. When cleaning or otherwise caring for an article of clothing, the application can use identifying information from the RFID tag to obtain laundering and cleaning instructions to facilitate proper care of the article of clothing. Such laundering and cleaning instructions can change based on other information such as age of item, number of times the item was previously laundered, and so on.

The world is moving towards the Internet of Things, interconnected by wireless internet access and databases, and featuring the many benefits of user control, location and temperature awareness, ability to store large amounts of modifiable data, and built-in intelligence. The systems, apparatus, and methods disclosed herein take advantage of such trends to the benefit of the seller of articles of commerce, the owner or purchaser of the article, and the public at large. The systems, apparatus, and methods are highly usable and cost effective via the use of secondary radio links such as Bluetooth and Wi-Fi that are already built into most mobile wireless devices such as smart phones, tablets, and smart watches, and that such mobile wireless devices have nearly ubiquitous access to the internet. The range of a Bluetooth link is sufficient to allow unobtrusive reading of information stored on an RFID tag attached to an article, including the identity of the article without intruding on the personal space of the owner or wearer of the article, but still limited enough that the mobile wireless device is not overloaded with too many such readings at once (allowing highly reliable identification, particularly when coupled with a confirming product picture downloaded to the wireless mobile device). The limited range also allows for highly accurate GPS based reporting of location of articles, which has many positive features, such as marketing feedback to sellers and tracking of stolen goods or lost children. The high density of smart phones and other mobile wireless devices in use also constitutes an available but highly under-utilized wireless network that with permission of users can provide reliable automated reading and location awareness of products to be located or tracked. The RFID tags that are so tracked may be relatively small, with unobtrusive small batteries such as lithium coin cells. In another embodiment, RFID tags can be relatively small are arranged without a battery. In such an embodiment, the RFID tag can include an energy storage device such as a capacitor, which receives energy from various energy harvesting mechanisms, methods, and techniques. Or in such an embodiment, the RFID tag can received energy directly from energy harvesting mechanisms, methods, and techniques.

Use of the systems, apparatus, and methods disclosed herein will only become more convenient and cost effective with time as the price and power consumption of secondary radio links such as Bluetooth continues to drop, and as the density of mobile wireless devices continues to rise. Addition of occasional fixed wireless devices will increase reliability of coverage at modest cost.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

We claim:

1. A method of procuring information about an item, comprising:
embedding electronics that include a wireless transmitter in the item;
associated the embedded electronics with the item;
transmitting information regarding the item from the embedded electronics on a periodic basis to a wireless receiver embedded in a handheld wireless device located in the general proximity of the item, where the handheld wireless device includes the capability to wirelessly query a remote database.

2. The method of claim 1, wherein the identifying information transmitted form the embedded electronics is used to verify the authenticity of the item.

3. The method of claim 1, wherein the query to the remote database returns information on regarding how the item or another item similar to the item can be procured.

4. The method of claim 1, wherein the information periodically transmitted regarding the item is stored for later use.

5. The method of claim 4, wherein the information periodically transmitted regarding the item includes information on the temperature experienced by the item.

6. The method of claim 5, wherein the stored information regarding the temperature experienced by the item is used for at least one of predicting the remaining service life of the item, improving the processes used to manufacture the item; and improving the design of the item.

7. The method of claim 6, wherein the item is a piece of apparel worn by a person.

8. The method of claim 1, further including requiring the detection of a security code prior to the embedded electronics transmitting information regarding the item.

9. The method of claim 1, further comprising a control function capable of selectively disabling the embedded electronics from transmitting information.

10. The method of claim 1, further comprising a control function capable of setting a period between transmission of information on a periodic basis.

11. The method of claim 1, further comprising a control function capable of setting a transmission power for the transmitting of information.

12. The method of claim 1, further comprising a control function capable of pairing the embedded electronics with one or more handheld wireless device.

13. The method of claim 12, wherein the transmission of information is limited to handheld wireless devices paired with the embedded electronics.

14. The method of claim 1, wherein the transmitted information includes at least one of the identity of the item, the identity of the user of the item, the location of the item, and the time the information was transmitted.

15. The method of claim 14, wherein the transmitted information of at least one of the identity of the item, the identity of the user of the item, the location of the item, and the time the information was transmitted is stored in a database.

16. The method of claim 1, wherein the embedded electronics includes a thin film battery.

17. The method of claim 1, wherein the embedded electronics includes an energy harvesting system.

18. The method of claim 1, wherein information is transmitted when the item is located in the proximity of another item of a same item class that includes embedded electronics.

19. The method of claim 1, wherein the detected strength of the transmitted information is used in part to determine the location of the item.

20. The method of claim 1, where an application is installed on the handheld mobile device to facilitate receiving of transmitted information and querying of the remote database.
